(19) United States
(12) Patent Application Publication
(10) Pub. No.: US 2021/0212383 A1
(43) Pub. Date: Jul. 15, 2021

(54) HEAT NOT BURN ELECTRONIC CIGARETTE ASSEMBLY AND POWER BANK

(71) Applicant: Lingxiao Li, Walnut, CA (US)

(72) Inventor: Lingxiao Li, Walnut, CA (US)

(21) Appl. No.: 17/147,336

(22) Filed: Jan. 12, 2021

Related U.S. Application Data
(60) Provisional application No. 62/960,545, filed on Jan. 13, 2020.

(51) Int. Cl. A24F 40/90; A24F 40/40; H01M 50/202; H01M 50/247; H02J 7/34

(52) U.S. Cl. CPC A24F 40/90; A24F 40/40; H01M 50/202; H01R 33/765; H02J 7/342; H01M 2220/30; H01M 50/247

(57) ABSTRACT

A heat not burn electronic cigarette assembly may include a heat not burn electronic cigarette and a power bank. The heat not burn electronic cigarette has at least one contact, and the heat not burn electronic cigarette is charged by the power bank. The power bank may include a case, a cover, a controller, a connector and a charger. The cover is coupled to the case to form an accommodation space, and the controller is disposed in the accommodation space. The connector is coupled to the controller, and the heat not burn electronic cigarette is charged via coupling the connector and the at least one contact. In one embodiment, the charger is coupled to the controller.

### FIELD OF THE INVENTION

The present application generally relates to electronic cigarettes, and more particularly, to a heat not burn electronic cigarette assembly and a power bank.

### BACKGROUND OF THE INVENTION

The two biggest concerns that stops customers from buying heat not burn electronic cigarette might be its poor portability and charging issue. Compares to traditional combustion cigarettes, users may have to carry a big and heavy heat not burn electronic cigarette beyond a pack of cigarette, instead of just a small lighter. Most of heat not burn electronic cigarettes have charging protection, which means users are not allowed to use the device while it is charged. Traditional combustion smokers would prefer to carry their cigarette and lighter anywhere they go, and smoke whenever they want.

Therefore, there remains a need for a heat not burn electronic cigarette assembly and a power bank to provide user a portable and convenient device with fast charging function.

### SUMMARY OF THE INVENTION

The present application discloses a heat not burn electronic cigarette assembly and a power bank to provide user a portable and convenient device with fast charging function. The heat not burn electronic cigarette assembly may include a heat not burn electronic cigarette and a power bank. In one embodiment, the heat not burn electronic cigarette comprises at least one contact, and is charged by the power bank. The power bank comprises a case, a cover, a controller, a connector and a charger. The cover is coupled to the case to form an accommodation space, the controller is disposed in the accommodation space, and the connector is coupled to the controller, wherein the heat not burn electronic cigarette is charged by coupling the connector and the contact. In one embodiment, the charger is coupled to the controller.

In various exemplary embodiments, the connector includes at least one pin. More specifically, the connector may include four pins while the heat not burn electronic cigarette comprises four contacts.

In various exemplary embodiments, the heat not burn electronic cigarette is coupled to the power bank via magnet. In a further embodiment, the charger is a battery.

In various exemplary embodiments, wherein a length of the power bank is 120 mm, and a length of the heat not burn electronic cigarette is 120 mm.

The present invention is advantageous because instead of carrying a giant one-piece electronic cigarette device, the user can only carry the heat not burn electronic cigarette when they go out to their smoking corner. More specifically, instead of charging the whole electronic cigarette device, the user can charge the power bank first, and the power bank charges the heat not burn electronic cigarette afterwards. As such, the present application not only decreases the inconvenience of bringing a huge device, but also allows the user to fast charge the heat not burn electronic cigarette.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a perspective view of a heat not burn electronic cigarette assembly.

FIG. 2 is an explosive view of a power bank of the heat not burn electronic cigarette assembly.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

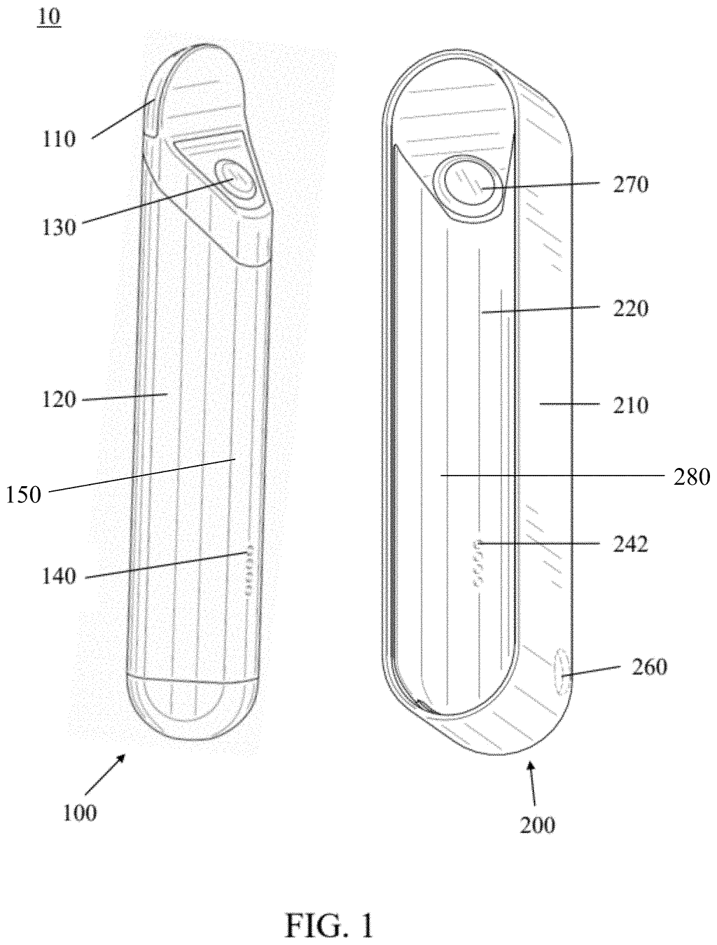

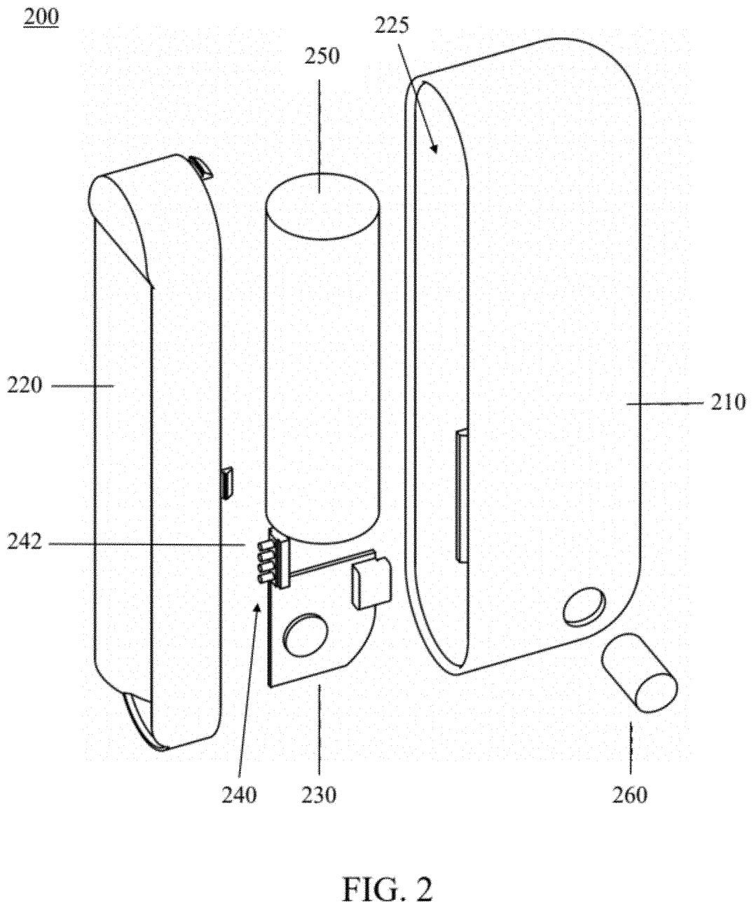

FIG. 1 is a perspective view of a heat not burn electronic cigarette assembly 10. FIG. 2 is an explosive view of a power bank 200 of the heat not burn electronic cigarette assembly 10.

In one embodiment, referring to FIGS. 1-2, the heat not burn electronic cigarette assembly 10 may include a heat not burn electronic cigarette 100 and the power bank 200. In one embodiment, a length of both of the heat not burn electronic cigarette 100 and the power bank 200 is 120 mm as an example but is not limited as long as the heat not burn electronic cigarette assembly 10 can be hold perfectly on hand. In one embodiment, the heat not burn electronic cigarette 100 is coupled to the power bank 200 via one or more magnets (150, 280), which can be located anywhere at the heat not burn electronic cigarette 100 and the power bank 200.

The heat not burn electronic cigarette 100 is charged by the power bank 200. In one embodiment, the heat not burn electronic cigarette 100 may include a detachable mouthpiece 110, a body 120, a protrusion 130 and at least one contact 140. In one embodiment, the contact 140 can be formed on the body 120. In a further embodiment, the heat not burn electronic cigarette 100 of the present application may include four contacts 140 on the body 120. The protrusion 130 is can be a switch of the heat not burn electronic cigarette 100 and people may turn on and off the electronic cigarette 100 by pressing the protrusion 130.

The power bank 200 may include a case 210, a cover 220, a controller 230, a connector 240, a charger 250, a cover 260 and a recess 270. The case 210 is coupled to the cover 220 to form an accommodation space 225. The shape of the case 210 can be any polygonal shape and is not limited to the shape in FIGS. 1 and 2, and the shape of the cover 220 is corresponded to the shape of the heat not burn electronic cigarette 100. For example, as shown in FIG. 1, the cover 220 is concave-shaped while the heat not burn electronic cigarette 100 is convex-shaped.

In one embodiment, the controller 230 is disposed in the accommodation space 225, and the connector 240 is coupled to the controller 230. The connector 240 may include at least one flexible pin 242. More specifically, the connector 240 in the present invention has four pins 242 and the heat not burn electronic cigarette 100 also has four corresponding contacts 140. The heat not burn electronic cigarette 100 is charged by coupling the pins 242 of the connector 240 and the contacts 140 of the heat not burn electronic cigarette 100.

The charger 250 is also coupled to the controller 230, and is a used for storing electric power for the heat not burn electronic cigarette 100. In one embodiment, it takes only around one minute to get the heat not burn electronic cigarette 100 be fully charged through the charger 250.

In a further embodiment, the charger 250 in the present application can be a battery. The battery may be one-time used battery or chargeable battery. Or, the battery may be charged via connecting the power bank 200 to AC power or DC power.

The cover 260 in the present application is made by acrylic cylinder, for example. More specifically, the cover 260 is transparent, allowing LED light from the controller 230 to pass through the cover 260. As such, the user may monitor the status of the heat not burn electronic cigarette assembly 10 simply by checking the light on the controller 230.

The recess 270 is coupled to the cover 220. The recess 270 of the power bank 200 and the protrusion 130 of the heat not burn electronic cigarette 100 are configured to engage with each other so that the power bank 200 and the heat not burn electronic cigarette 100 can be more stably engaged while charging.

Based on the above, instead of carrying a huge one-piece electronic cigarette device, the user can only carry the heat not burn electronic cigarette when they go out to their smoking corner. More specifically, instead of charging the whole electronic cigarette device, the present application allows user to charge the power bank first, and the power bank charges the heat not burn electronic cigarette afterwards. As such, the present application not only decreases the inconvenience of bringing a huge device, but also allows the user to fast charge the heat not burn electronic cigarette.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A heat not burn electronic cigarette assembly comprising:
a heat not burn electronic cigarette comprising at least one contact; and
a power bank to charge the heat not burn electronic cigarette is charged by the power bank; said power bank comprising:
a case;
a cover coupled to the case to form an accommodation space;
a controller disposed in said accommodation space;
a connector coupled to the controller, and said connector configured to charge the heat not burn electronic cigarette by coupling to the at least one contact; and
a charger coupled to the controller,
wherein the heat not burn electronic cigarette is configured to be charged by the power bank, and a user can use the heat not burn electronic cigarette without the power bank after the electronic cigarette is being charged.

2. The heat not burn electronic cigarette assembly of claim 1, wherein the connector comprises at least one pin.

3. The heat not burn electronic cigarette assembly of claim 2, wherein the connector comprises four pins and the heat not burn electronic cigarette comprises four corresponding contacts.

4. The heat not burn electronic cigarette assembly of claim 1, wherein the heat not burn electronic cigarette is coupled to the power bank via one or more magnet.

5. The heat not burn electronic cigarette assembly of claim 1, wherein the charger is a battery.

6. The heat not burn electronic cigarette assembly of claim 1, wherein a length of the power bank is 120 mm.

7. The heat not burn electronic cigarette assembly of claim 1, wherein a length of the heat not burn electronic cigarette is 120 mm.

8. A power bank for charging an electronic cigarette comprising:
a case;
a cover coupled to the case to form an accommodation space;
a controller disposed in the accommodation space;
a connector coupled to the controller, wherein at least one contact of the electronic cigarette is coupled to the connecter when charging; and
a charger coupled to the controller.
wherein the electronic cigarette is configured to be charged by the power bank, and a user can use the electronic cigarette without the power bank after the electronic cigarette is being charged.

9. The power bank for charging the heat not burn electronic cigarette as claimed in claim 8, wherein the connector comprises at least one pin.

10. The power bank for charging the heat not burn electronic cigarette as claimed in claim 9, wherein the connector comprises four pins and the heat not burn electronic cigarette comprises four corresponding contacts.

11. The power bank for charging the heat not burn electronic cigarette as claimed in claim 8, wherein the heat not burn electronic cigarette is coupled to the power bank via one or more magnets.

12. The power bank for charging the heat not burn electronic cigarette as claimed in claim 8, wherein the charger is a battery.

13. The power bank for charging the heat not burn electronic cigarette as claimed in claim 8, wherein a length of the power bank is 120 mm.
